(19) United States
(12) Patent Application Publication
(10) Pub. No.: US 2015/0127601 A1
(43) Pub. Date: May 7, 2015

(54) SYSTEM AND METHOD FOR IMPROVING AND MANAGING SMART GRID UNREAD METER INVESTIGATIONS

(71) Applicant: Florida Power & light Company, Juno Beach, FL (US)

(72) Inventors: Peter F. McGill, Pembroke Pines, FL (US); Tavaris Latimore, Miami, FL (US); Maria Pombo, Miami, FL (US); Hitendra Savdas, Port Saint Lucie, FL (US); Baskaran Sivasubramanian, Jupiter, FL (US)

(73) Assignee: Florida Power & light Company, Juno Beach, FL (US)

(21) Appl. No.: 14/532,326

(22) Filed: Nov. 4, 2014

Related U.S. Application Data
(60) Provisional application No. 61/899,635, filed on Nov. 4, 2013.

(51) Int. Cl. G06F 17/30

(52) U.S. Cl. CPC G06F 17/30554
USPC 707/603; 707/737

(57) ABSTRACT

The system and method of the present disclosure generally comprises a widget that collects and organizes pertinent meter-centric investigation information; allows quick and easy access to additional detail; provides the ability to make updates; and interfaces with other applications through, for example, automated meter change orders. The system and method of the present disclosure further comprises several inquiry modules, including but not limited to an unread meter work queue, unread meter priority work queue, meter cancellation widget, and unread meter work queue administration.

### CROSS REFERENCE TO RELATED APPLICATIONS

This application claims the benefit of U.S. Provisional Application No. 61/899,635, filed Nov. 4, 2013 the disclosure of which is hereby incorporated herein by reference in its entirety.

### FIELD OF THE INVENTION

The present disclosure relates to a system and method for improving advanced metering infrastructure (“Smart Grid”) operations with smart grid analytics.

### BACKGROUND

Given the increasing pace of business, utility companies often utilize visual analytics for rapid, timely decision-making. These visual analytics have included the use of smart metering dashboards, customer experience dashboards, remote connect service dashboards, and meter operations processes. Various dashboards can combine customer data and geospatial information for situational analysis. There are many advantages in utilizing visual analytics to improve and develop smart meter operations.

Uses of smart meter networks and visual analytics have become increasingly critical to utility providers. Examples of the kinds of operations that can benefit from smart meter data include billing, customer dashboards, distribution automation, theft detection, outage verification, proactive outage/restoration confirmation, Remote Connect Service (“RCS”), and power quality.

Smart grid meter operations are often operated by smart grid meter operation and network teams. For example, a smart grid network team may be comprised of one or more network technicians, lead technicians, and supervisors that are strategically placed in work regions. A smart grid operations team may be centralized in one office and may be comprised of one or more representatives, lead representatives, and supervisors. The objectives of the operations team may include: developing a team with appropriate skill sets; developing formalized work procedures; embedding service level agreements (SLAs) into processes; maintaining open communications with stakeholders; and developing tools to make better, quicker decisions. Due to the growing volume of work in the utility industry, these smart grid operations and network teams can no longer rely on Excel and Access databases.

Utility companies have installed and activated millions of smart meters throughout the country. To meet business demands, smart grid meter operations dashboards became more interactive, allowing utility companies to efficiently investigate and address meter problems. Despite the advantages rendered by use of dashboards, when smart meters stop communicating with the Smart Grid network there is little information that can be gathered through the use of a dashboard unless analytics are applied to figure out the cause of the meter failure. Thus, there is still a need for a smart grid dashboard which provides an improved and integrated data view, and which enables dynamic investigations and actions based on smart meter analytics.

### SUMMARY

The following presents a simplified summary of the disclosure in order to provide a basic understanding of some aspects of the disclosure. This summary is not an extensive overview of the disclosure. It is intended to neither identify key or critical elements of the disclosure nor delineate the scope of the system and method disclosed herein. Its sole purpose is to present some concepts of the disclosure in a simplified form as a prelude to the more detailed description that is presented later.

The system and method of the present disclosure generally comprises a widget that collects and organizes pertinent meter-centric investigation information; allows quick and easy access to additional detail; provides the ability to make updates; and interfaces with other applications through, for example, automated meter change orders.

The system and method of the present disclosure further comprises several inquiry modules, including but not limited to an unread meter work queue, unread meter priority work queue, meter cancellation widget, and unread meter work queue administration.

In one embodiment, an application based on space-time-insight (“STI”) software is used to permit teams to assemble with Agile methodology for rapid development. “Quick-hit” monitoring widgets are incorporated into the space-time-insight application.

In one embodiment, additional operations and network tools are utilized to create more timely insights into business conditions, including but not limited to the following:
Conducting analysis to set the right thresholds;
Non-communications assessment period revised to minimize false-positive conditions;
Identifying common reasons/buckets for non-communications;
Consolidating data elements from most-used systems in non-communicating investigations (e.g., Customer Information System, distribution and field operations work management systems, customer outage history, theft history, etc.);
Developing an administration screen to assign work;
Deploying capability to separate meter clusters for the field operations team; and
Incorporating reporting capabilities specific to the non-communications process.

The following description and the annexed drawings set forth in detail certain illustrative aspects of the disclosure. These aspects are indicative, however, of but a few of the various ways in which the principles of the system and method disclosed herein may be employed and the system and method disclosed herein is intended to include all such aspects and their equivalents. Other advantages and novel features of the system and method disclosed herein will become apparent from the following detailed description of the system and method disclosed herein when considered in conjunction with the drawings.

### BRIEF DESCRIPTION OF THE DRAWINGS

FIG. 1 shows that FIG. IA should be read in conjunction with FIG. 1B.

FIGS. IA-B illustrate a flow diagram for reviewing read rates and non-communicating meters, and for initiating network investigation requests or meter change orders in accordance with one embodiment.

FIG. 2 illustrates a flow diagram of various inquiry modules associated with one embodiment.

FIG. 3 illustrates an unread meters work queue chart in accordance with one embodiment.

FIG. 4 illustrates widgets displaying meter information corresponding to a customer premise in accordance with one embodiment.

FIG. 5 illustrates a chart report of meter-related actions in accordance with one embodiment.

FIG. 6 shows that FIG. 6A should be read in conjunction with FIG. 6B.

FIGS. 6A-B illustrate an unread meter investigation dashboard in accordance with one embodiment.

FIG. 7 illustrates an unread meter update work queue user interface in accordance with one embodiment.

FIG. 8 illustrates an unread meters work queue report for smart meters that have been accepted into billing in accordance with one embodiment.

FIG. 9 illustrates a work administration user interface in accordance with one embodiment.

FIG. 10 illustrates an STI dashboard architecture for a Smart Meter Infrastructure in accordance with one embodiment.

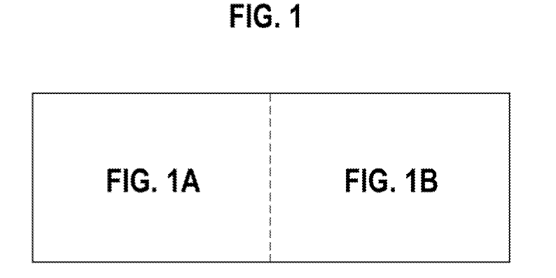

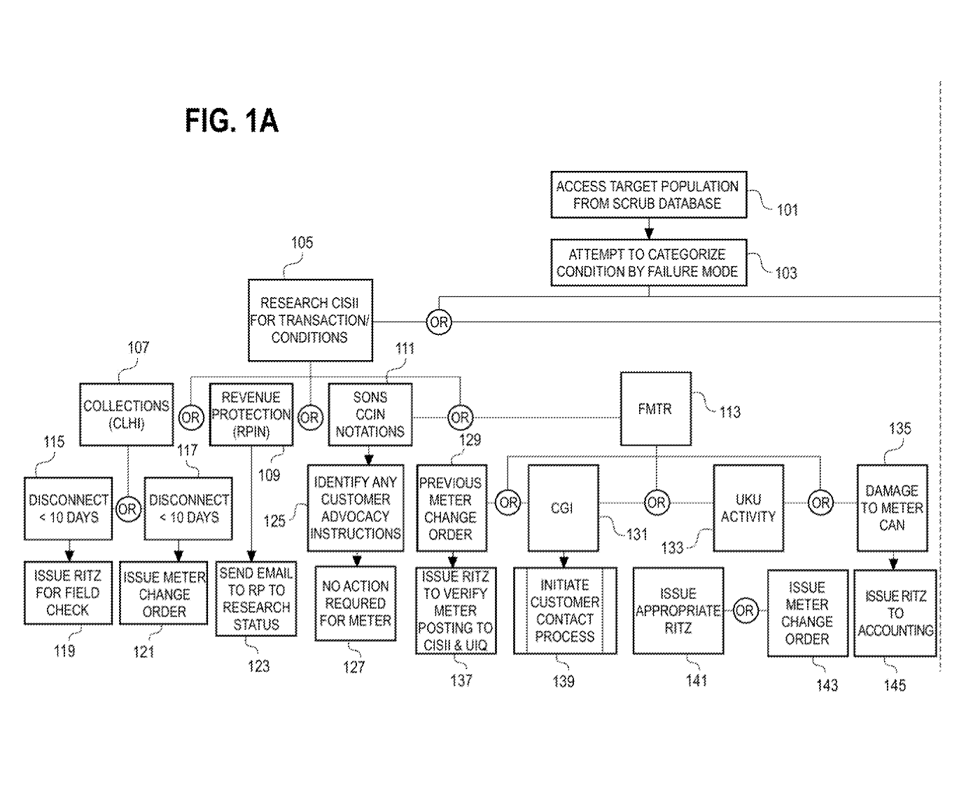

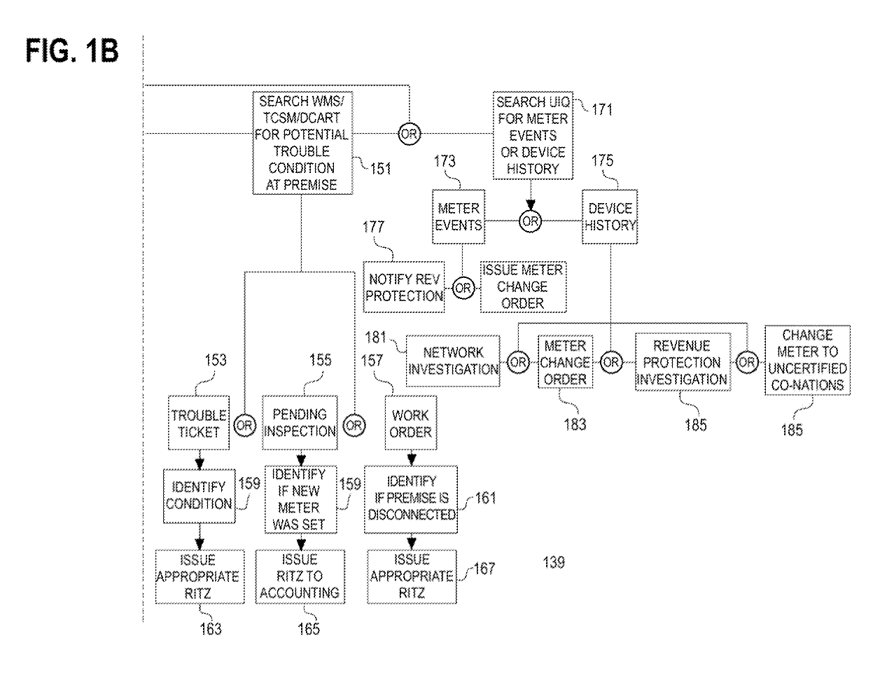

### DESCRIPTION OF ILLUSTRATIVE EMBODIMENTS

The system and method disclosed herein will now be described more fully hereinafter with reference to the accompanying drawings, in which preferred embodiments of the system and method disclosed herein are shown. The system and method disclosed herein may, however, be embodied in many different forms and should not be construed as limited to the embodiments set forth herein. Rather, these embodiments are provided so that this disclosure will be thorough and complete, and will fully convey the scope of the system and method disclosed herein to those skilled in the art.

As will be appreciated by those skilled in the art, portions of the present system and method may be embodied as a method, data processing system, or computer program product. Accordingly, these portions of the present system and method disclosed herein may take the form of an entirely hardware embodiment, an entirely software embodiment, or an embodiment combining software and hardware aspects. Furthermore, portions of the present system and method may be implemented as a computer program product on a computer-usable storage medium having computer readable program code on the medium. Any suitable computer readable medium may be utilized including, but not limited to, static and dynamic storage devices, hard disks, optical storage devices, and magnetic storage devices.

The present system and method is described below with reference to illustrations of methods, systems, and computer program products according to the disclosed embodiments. It will be understood that blocks of the illustrations, and combinations of blocks in the illustrations, can be implemented by computer program instructions, hardware devices, or a combination of both. These computer program instructions may be provided to a processor of a general purpose computer, special purpose computer, or other programmable data processing apparatus to produce a particular machine, such that the instructions, which execute via the processor of the computer or other programmable data processing apparatus, implement the functions specified in the block or blocks.

Embodiments of present system and method may be implemented on one or more computing devices, including one or more servers, one or more client terminals, including computer terminals, a combination thereof, or on any of the myriad of computing devices currently known in the art, including without limitation, personal computers, laptops, notebooks, tablet computers, touch pads (such as the Apple iPad, SmartPad Android tablet, etc.), multi-touch devices, smart phones, personal digital assistants, other multi-function devices, stand-alone kiosks, etc.

With reference to FIGS. IA-B, the system and method disclosed herein comprise a target population consisting of a population of unread smart meters (e.g., meters that no longer communicate with the Smart Grid network). This target population is accessed from a scrub database (101) that includes data indicative of unread smart meters and which needs to be investigated. The system and method disclosed herein then attempts to categorize a condition by failure mode (103).

In one embodiment, the system and method disclosed herein may research a customer information system (“CIS”) for transaction/conditions (105). In researching the CIS, the system may execute one or more functions including but not limited to the following: a collection activity history (“CLH”) (107); a revenue protection investigation inquiry (“RPIN”) (109); a special notations/customer contact inquiry (“SONS/CCIN notations”) (111); or a field meter change order (“FMTR”) (113).

If the system and method disclosed herein is executing a collections function (107), the system may disconnect a meter in less than 10 days (115) and issue a Request Issuance Tracking System (“RITS”) for Field Check (119); or alternatively, disconnect a meter in over 10 days (117) and issue a meter change order (121). If the system and method disclosed herein is executing a revenue protection function (109), the system may send an email to Revenue Protection (“RP”) to research the status of the meter (123). If the system is executing a SONS/CCIN notations function (111), the system may identify any customer advocacy instructions (125) wherein no action will be required for the meter (127).

In an embodiment where the system and method disclosed herein is executing an FMTR function (113), the system may take one or more of the following actions: the system may detect a previous meter change order (129) wherein the system issues a RITS to verify meter posting to the CIS and to Utility Intelligence Quotient (“UIQ”) (137); the system may execute a Can't Get In (“CGI”) function (131) wherein a customer contact process is initiated (139); the system may detect Unknown User activity (“UKU activity”) (133) and either issue the appropriate RITS (141) or issue a meter change order (143); or, the system and method may report damage to a meter (135) and issue a RITS to accounting (145).

Once the system accesses a target population from the scrub database, and attempts to categorize a condition by failure mode, in yet another embodiment, the system and method disclosed herein may search a Work Management System/Trouble Call Management System/Distribution Customer Analysis and Research Tool (“WMS/TCSM/DCART”) for potential trouble conditions at the premises (151). In this embodiment the system and method disclosed herein may execute a variety of functions including but not limited to the following: the system may issue a trouble ticket (153), wherein a condition is identified (159), and an appropriate RITS is issued (163); the system may execute a pending inspection (155) wherein the system identifies if a new meter was set (159) and an appropriate RITS is issued (165); or, the system may execute a work order (157) wherein the system identifies whether the premise is disconnected (161) and issue an appropriate RITS (167).

Once the system and method disclosed herein accesses a target population from scrub database, and attempts to categorize conditions by failure mode, in yet another embodiment, the system and method disclosed herein may search UIQ for meter events and device history (171).

In this embodiment, the system and method disclosed herein may execute a meter events function (173) or device history function (175). If the system executes a meter events function, the system may notify revenue protection (177) or issue a meter change order (179). If the system executes a device history function (175), the system may further execute any of the following functions: network investigation (181), meter change order (183), revenue protection investigation (185), or change meter to uncertified conditions (187).

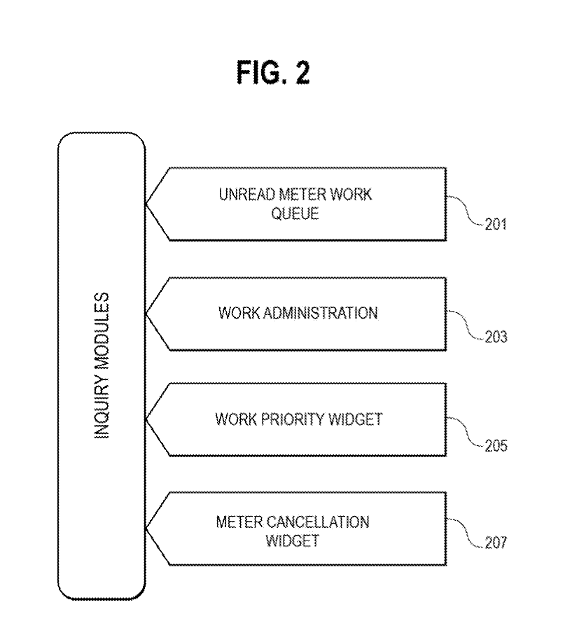

With reference to FIG. 2, the system and method disclosed herein comprises a plurality of inquiry modules which can be accessed from a single user interface or location. The unread meter work queue widget (201) categorizes certified meters that have not been read in several days based on existing work tickets that are associated to a smart meter. The unread meter priority work queue (205) is a widget that categorizes certified meters that have not been read in several days based on existing work tickets that are associated to a smart meter, that have an action associated to it (e.g., Meter Change), and wherein the meter is read after a certain number of days from when the action is taken. The meter cancellation widget (207) is a widget that displays unread meters that have a meter change action associated to the meter, and which is read within a certain number of days. The unread meter work queue administration widget (203) provides a mechanism to assign work to individuals in the work queue and helps supervisors manage work progression. Use of widgets in computing apparatuses is known in the art. For example, U.S. Pat. Nos. 8,117,555; 8,255,186; and 8,266,537, incorporated herein by reference, disclose the use of widgets in computing devices for different applications.

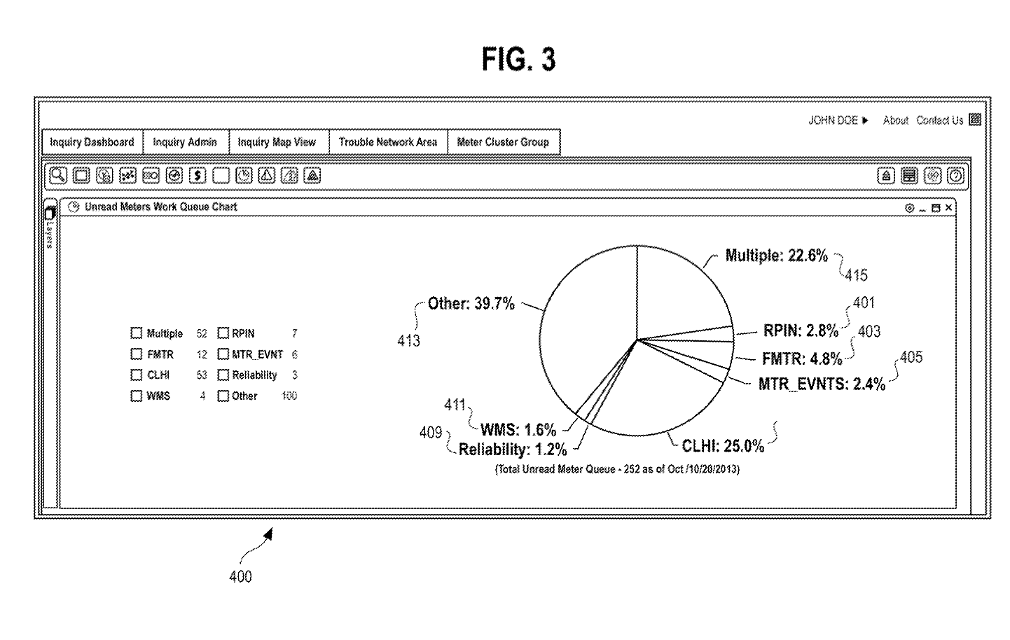

FIG. 3 illustrates an unread meters work queue chart in accordance with one embodiment. In the illustrated embodiment, the work queues are RPIN (401) (“revenue protection investigation pending”), FMTR (403) (“field meter ticket pending”), Meter Events or prescribed number of specific meter event that may indicate a meter issue (MTR_EVNTS) (405), CLHI (407) (“collection activity on the account”), Reliability (409) (e.g., trouble ticket completed for the premise), WMS (411) (e.g., work management ticket pending or completed at the premise), Other (413) (i.e., none of the foregoing is present), Multiple (415) (e.g., more than one of the foregoing at the premise).

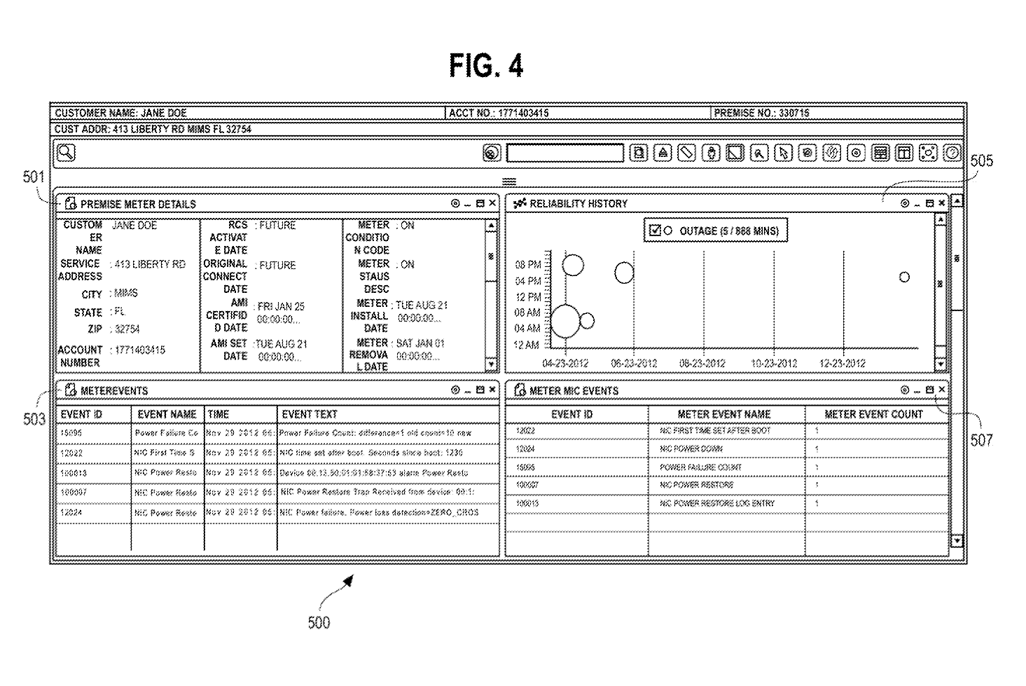

FIG. 4 is an illustration of a GUI 500 that ties four widgets for displaying meter information corresponding to a customer premise in accordance with one embodiment. The GUI 500 ties the following widgets: a premise meter details widget 501, a meter events widget 503, a reliability history widget 505, and a meter/NIC events widget (related to network interface card which may indicate issue with a meter can or with a meter).

The premise meter details widget 501 may display the following information: the customer's name and address, the account number, remote connect service information, date of original connection, AMI certification date, AMI set date, meter condition code, meter status description, meter installation date, and meter removal date.

The reliability history widget 505 may display power outage information corresponding to the premise. Power outages may be represented by a dot or circle, with the size of the circle corresponding to the duration of the outage experienced by the customer.

The meter events widget 503 may display information to identify the event by number, by name and by time of occurrence. The widget 503 may also display text to describe the event. The meter/NIC events widget 507 may display information to identify the event by number and by name, and it may also display an event count.

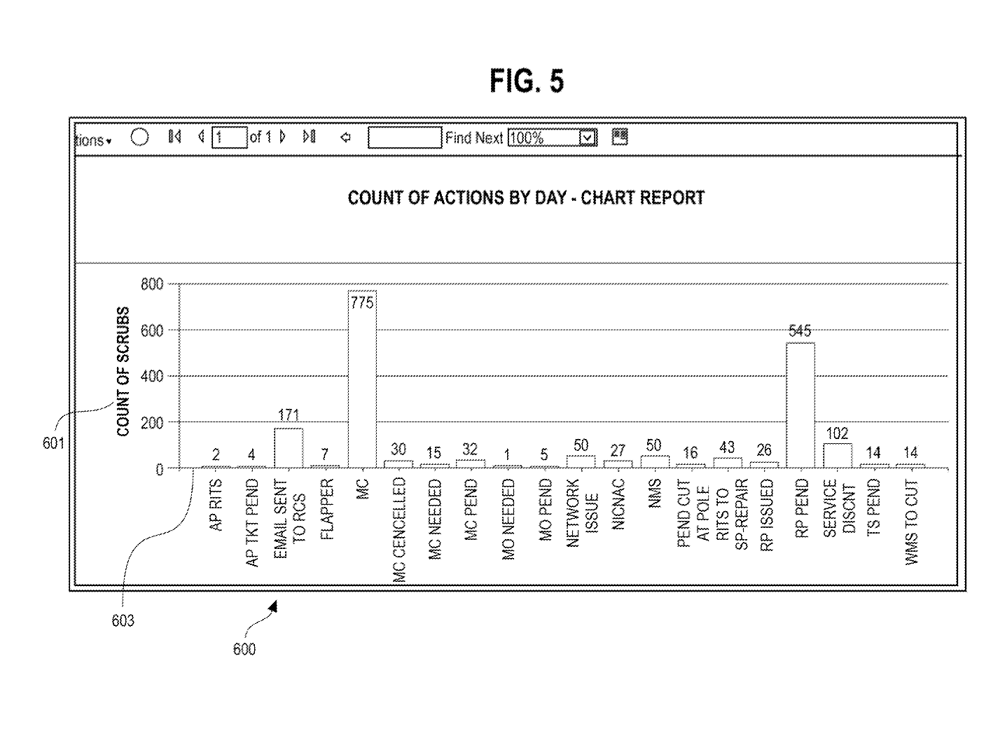

FIG. 5 illustrates a chart report 600 of meter-related actions in accordance with one embodiment. The y-axis corresponds to the count of actions 601 with respect to scrubs or unread smart meters, while the x-axis corresponds to the type of action 603. These are the reasons/actions taken as a result of the meter not communicating.

The actions in the illustrated embodiment include: AP RITS, AP Ticket Pending (Appointment ticket scheduled or already scheduled to change the meter), email sent to RCS (Lost communication After Remote Connect Switch was operated), Flapper (meter going in and out of communication), Meter Change (MC) (meter change order is issued), MC Cancelled (meter change order was cancelled because the meter started reading again and it is no longer needed), MC Needed (meter read after meter change was issued but it still needs to be changed), MC pending (meter change is pending on the account already), network issue (weak/no communication is the issue that needs to be investigated by Network Operation team), NICNAC (specific meter condition that needs to be rectified by Support team), Pending Cut at Pole (order pending to cut service at the pole), RITS to Service Planning (SP) (initiate process to have customer repair meter can before we install another meter), RP Issued (theft is suspected so order issued to Revenue Protection), RP Pending (Revenue Protection order is pending), Service Discount (Identified that the meter has no power), TS Pending (Take service order is pending on the account), and WMS to Cut (order issued to cut service at the poll if we don't have access to meter or suspect theft).

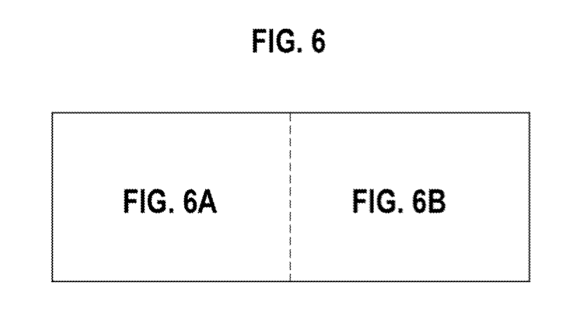

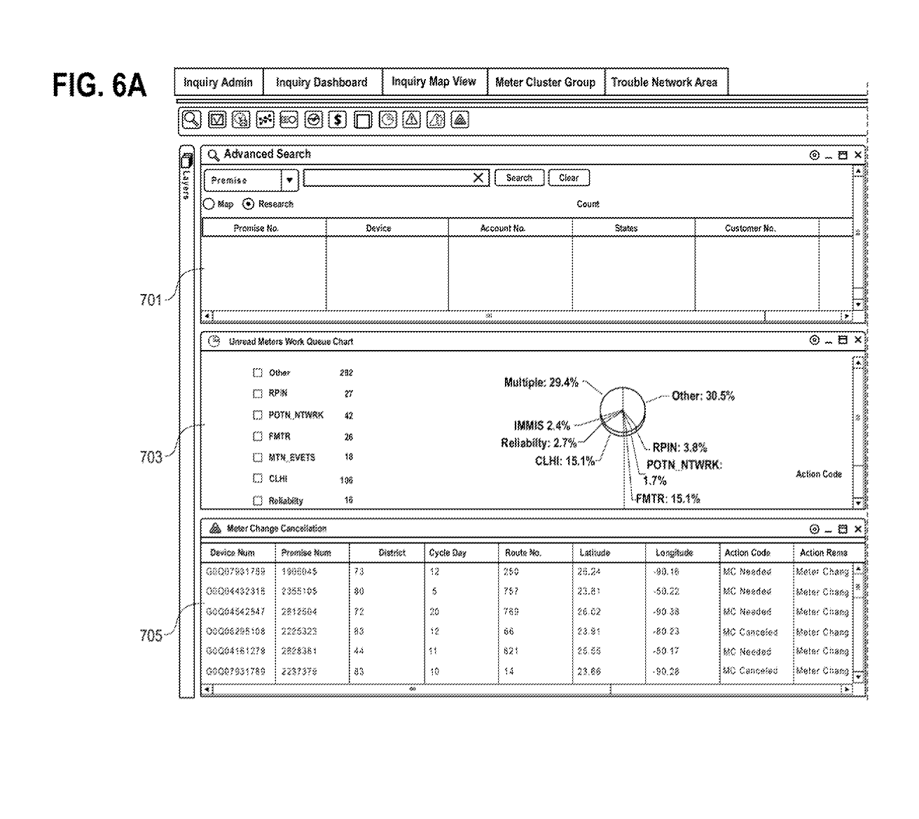

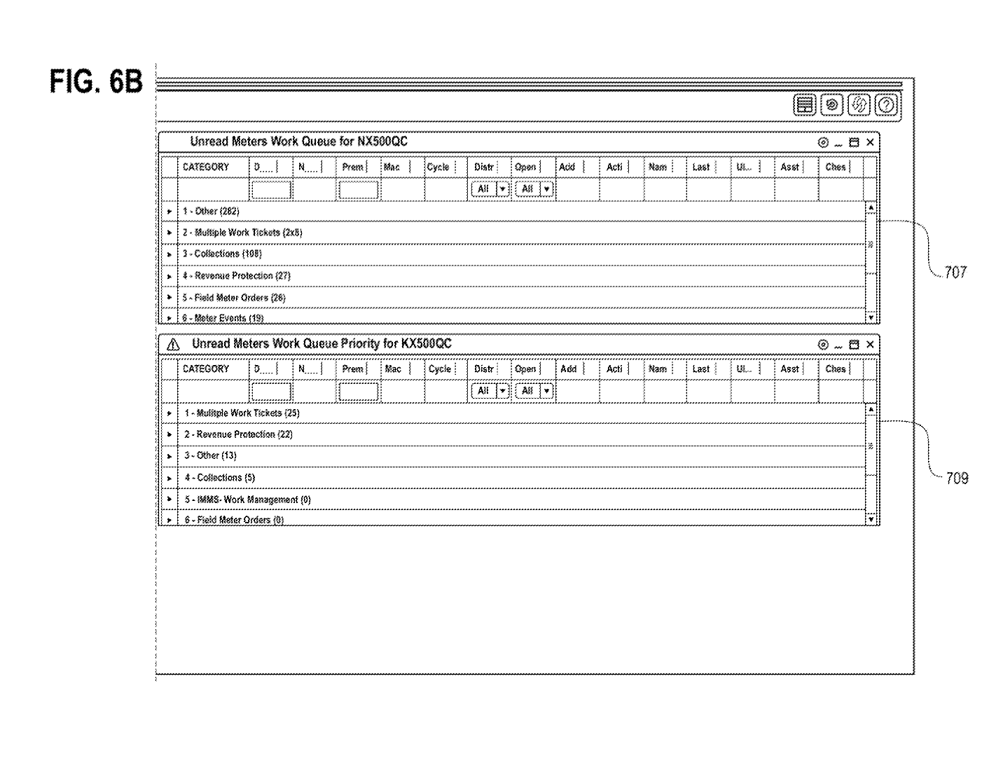

FIGS. 6A-B illustrate an unread meter investigation dashboard in accordance with one embodiment. The widget 701 may be used to conduct a search of unread meters. The widget 703 may display a chart similar to the chart in FIG. 3 with respect to the unread meter work queue. The meter change/cancellation widget may display the following meter data: device number, premise number, district, cycle day, route number, latitude, longitude, meter action code and meter action name.

Widgets 707 and 709 provide information related to the work queue of a particular type of unread meter work queue widgets. 707 shows assigned unread work queue assigned to specific representative and 709 shows assigned unread priority work queue assigned to specific representative.

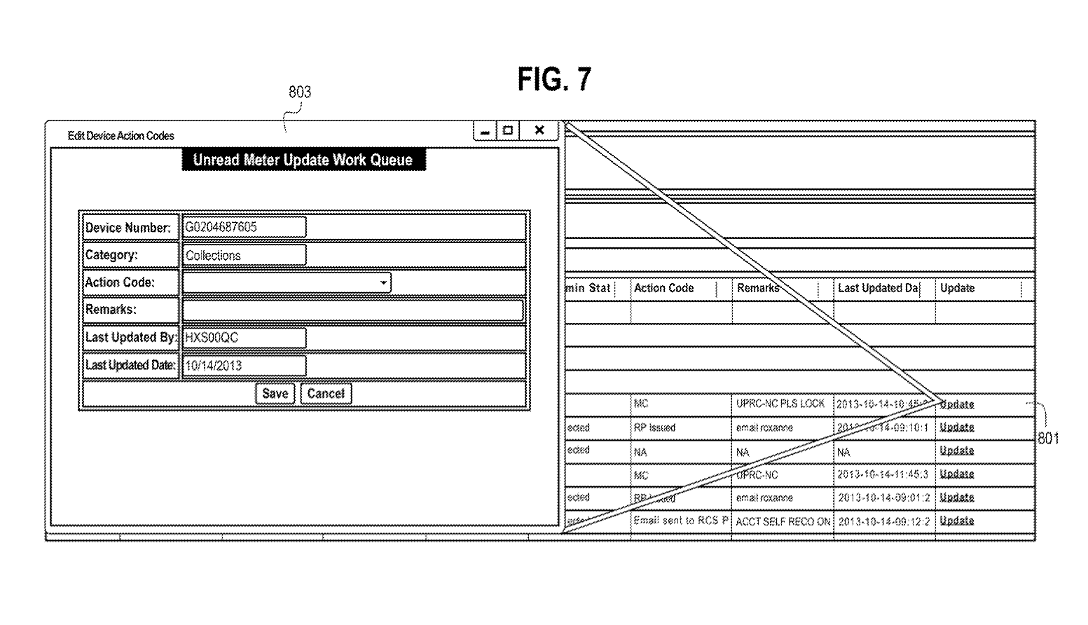

FIG. 7 illustrates an unread meter update work queue user interface 803 in accordance with one embodiment. The user interface 803 pops up when the update link 801 is activated by a user. The interface 803 allows a user to edit device action codes in connection with the unread meter work queue.

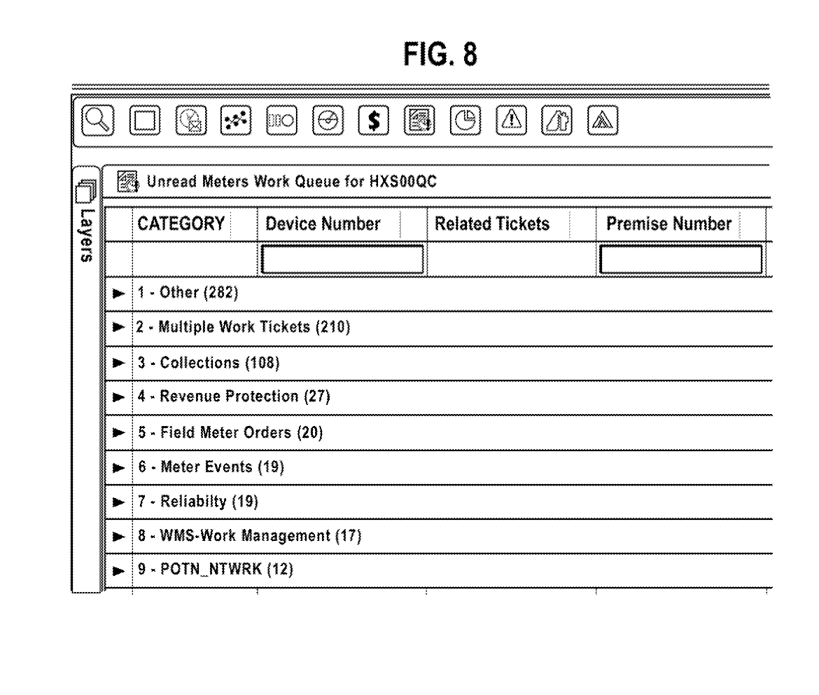

FIG. 8 illustrates an unread meters work queue report for smart meters that have been accepted into billing in accordance with one embodiment. The report in FIG. 8 is similar to the report displayed by widget 707 in FIG. 6.

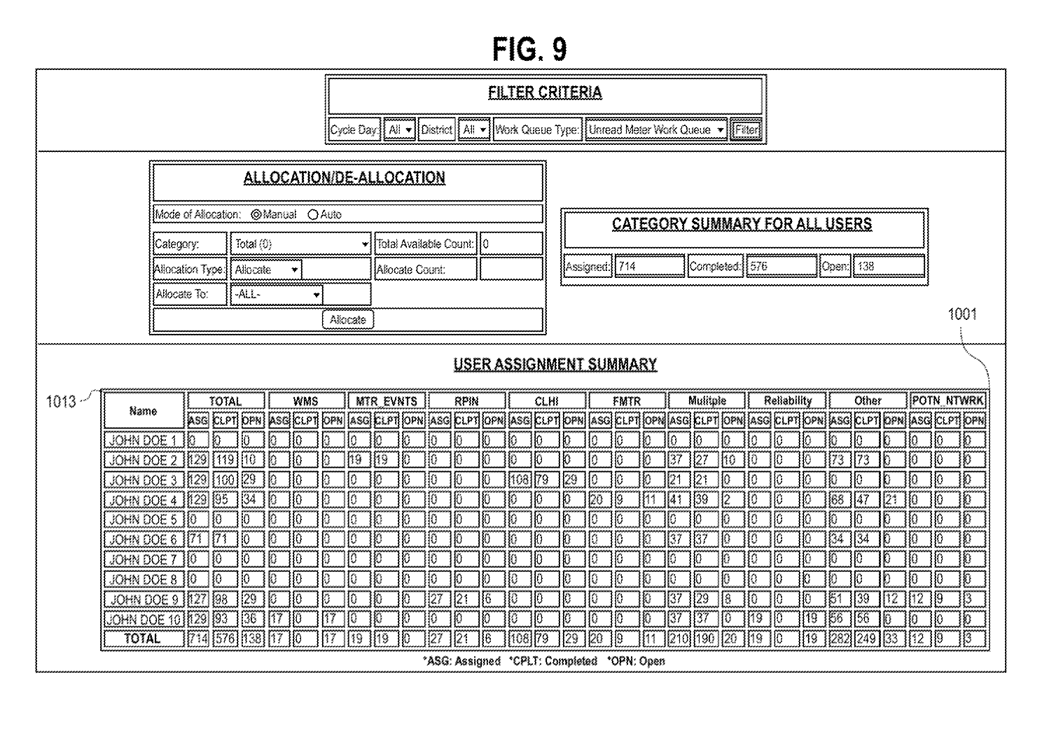

FIG. 9 illustrates another report related to the unread meter work queue. In the illustrated embodiment, the types of work queue 1001 are categorized as being assigned, completed or open by different personnel 1013. These tasks are similar to the tasks illustrated in FIG. 3.

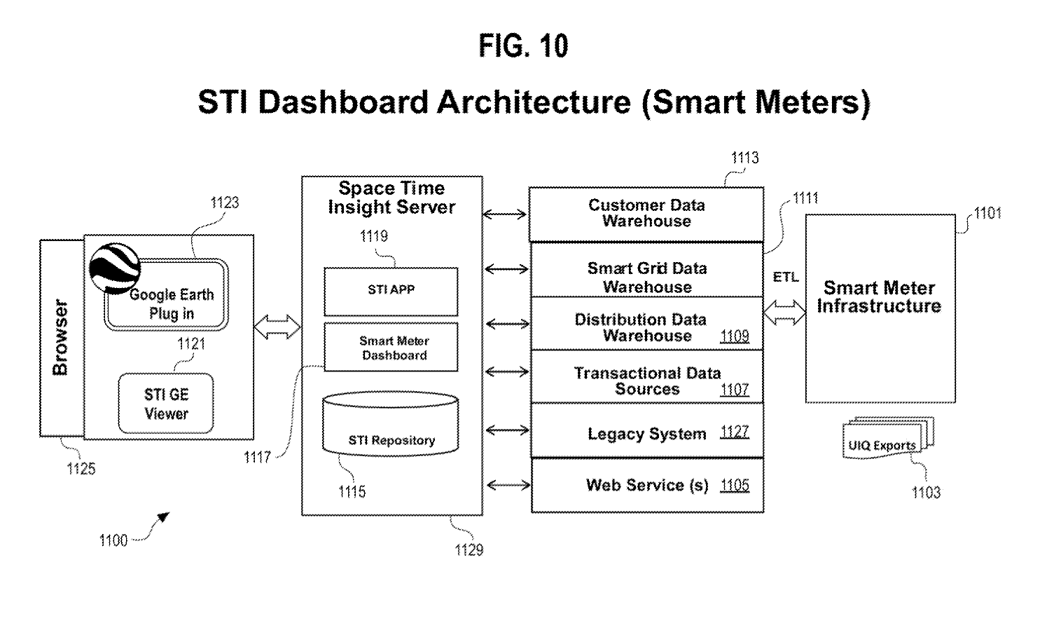

FIG. 10 illustrates an STI dashboard architecture 1100 for a Smart Meter Infrastructure in accordance with one embodiment. As illustrated by FIG. 10, the architecture 1100 may be used for integrating the smart meter infrastructure 1101 with other third party tools including the STI server 1129, Google Earth 1123 and web browsers 1125. The connection may be established through an Ethernet Link (“ETL”). The STI GE Viewer 1121 may be defined as a tool component to present data on a Google Earth map. The Google Earth Plug-in 1123 is the tool from Google Earth that may be used for integration with the Unread Meter application via the STI GE viewer 1121. The browser 1125 may be any web browser used to display STI applications.

The STI module or server 1129 refers to space time insight reporting. Space Time Insight (STI) is a software development tool for integrating data sources into visualization.

In FIG. 10, the Smart Meter Infrastructure 1101 may be defined as an operational data store for all meter data collected from scheduled read jobs and dynamic events triggered from the meter to alert to power down conditions.

The UIQ Exports (1103) may be defined as monitoring tools for an Information Management (IM) business unit to manage the technical environment. These tools support the collection of inputs from the network (meters, relays, access points, scheduled read jobs to pull meter usage, etc.) and the pairing and export of specific data transactions to create data marts for enterprise business consumption. The data generated by the Smart Meter Infrastructure 1101 (or AMI network) is shared with a number of data warehouses through the use of web services, for further use by various widgets.

As further illustrated by FIG. 10, the STI server 1129 comprises an STI application 1119, Smart Meter dashboard 1117, and STI Repository 1115 and may receive information from the following data warehouses: customer data warehouse 1113, Smart Grid data warehouse 1111, distribution data warehouse 1109, transaction data sources 1107, legacy system 1127, and web services 1105.

Further referring to FIG. 10, the STI Repository (1115) may be defined as application libraries that support the executable applications; the Smart Meter Dashboard (1117) may be defined as the body or repository of widgets (visuals) to make up the Unread Meter application; and the STI APP (1119) may be defined as a tool layer that enables the developed Unread Meter application to work.

The foregoing description of possible implementations consistent with the method and system disclosed herein does not represent a comprehensive list of all such implementations or all variations of the implementations described. The description of only some implementation should not be construed as an intent to exclude other implementations. For example, artisans will understand how to implement the system and method disclosed herein in many other ways, using equivalents and alternatives that do not depart from the scope of the system and method disclosed herein. Moreover, unless indicated to the contrary in the preceding description, none of the components described in the implementations are essential to the system and method disclosed herein. It is thus intended that the specification and examples be considered as exemplary only.

1. A method for processing unread meter investigation requests comprising:
accessing a target population of unread smart meters from a scrub database; and
categorizing a condition of an unread meter by failure mode, said categorizing step comprising
searching for transactions or conditions in a customer information system.

2. The method of claim 1, further comprising:
reviewing a collection activity history;
disconnecting a meter; and
generating an issue ticket for a meter field check or generating a meter change order.

3. The method of claim 1, further comprising:
performing a revenue protection investigation inquiry; and
generating a notification to a revenue protection system with a request to research the status of the meter.

4. The method of claim 1, further comprising:
performing a customer contact inquiry; and
identifying customer advocacy instructions.

5. The method of claim 1, further comprising:
executing a field meter change order function;
detecting a previous meter change order; and
generating a request to verify that meter information has been posted to the customer information system and to a Utility Intelligence Quotient system.

6. The method of claim 1, further comprising:
executing a field meter change order function; and
executing a CGI function wherein a customer contact process is initiated.

7. The method of claim 1, further comprising:
executing a field meter change order function;
executing an UKU function; and
generating an issue ticket for a meter field check or generating a meter change order.

8. The method of claim 1, further comprising:
executing a field meter change order function;
reporting damage to a meter; and
generating an issue ticket to an accounting system.
